(19) United States
(12) Patent Application Publication
(10) Pub. No.: US 2008/0025871 A1
(43) Pub. Date: Jan. 31, 2008

(54) Low-loss storage system for liquid slurries of small particles

(75) Inventors: John M. Dzenitis, Danville, CA (US); Benjamin J. Hindson, Belmont (AU); Anthony J. Makarewicz, Livermore, CA (US); William J. Benett, Livermore, CA (US); Aaron M. Mason, Wilmington, MA (US); Paul B. Haigh, Wilmington, MA (US)

Correspondence Address: Eddie E. Scott;Assistant Laboratory Counsel, Lawrence Livermore National Laboratory, P.O. Box 808, L-703, Livermore, CA, 94551, US

(73) Assignee: The Regents of the University of California

(21) Appl. No.: 11/495,952

(22) Filed: Jul. 27, 2006

(51) Int. Cl. B01L 3/00; G01N 21/00

(52) U.S. Cl. 422/55; 422/99

(57) ABSTRACT

A system for maintaining a liquid slurry of microbeads for use in biological or chemical analysis comprising providing a flexible bag and filling the flexible bag with a slurry of a liquid and microbeads. One embodiment is an apparatus for maintaining liquid slurries of particles for use in biological or chemical analysis comprising a bag, a liquid contained within the bag, and particles contained within the liquid in the bag.

The United States Government has rights in this invention pursuant to Contract No. W-7405-ENG-48 between the United States Department of Energy and the University of California for the operation of Lawrence Livermore National Laboratory.

### BACKGROUND

1. Field of Endeavor

The present invention relates to biological or chemical analysis and more particularly to a low-loss storage system for liquid slurries of small particles used in biological or chemical analysis.

2. State of Technology

U.S. Pat. No. 6,905,885 issued Jun. 14, 2005 to Billy W. Colston, Matthew Everett, Fred P. Milanovich, Steve B. Brown, Kodumudi Vendateswaran, and Jonathan N. Simon, provides the following state of technology information, “By use of the Liquid Array, additional assays can be added simply by addition of different color bead sets. Up to 100-plex assay can now be performed using a 10×10 array of microbead sets developed by Luminex Corporation, Austin, Tex. under U.S. Pat. No. 6,057,107 issued May 2, 2000 to J. R. Fulton. Each microbead is individually doped with two fluorescent dyes (orange and red), wherein a liquid array shows the absolute intensity of the two dyes (orange and red) as indicated by legend and arrows and which provides a method to uniquely identify each microbead set. Given the existing Luminex Corp. bead set, two different types of multiplex analysis can now occur. The first involves multiplexed detection of different biomarkers in the sample wherein each bead color is used to identify a specific bioagent assay. In this approach, a sample is added to a collection of microbeads. Each color or microbeads contains a capture assay that is specific for a given bioagent. Fluorescent labels are then added to identify the presence of each agent on the bound bead. In the second type of multiplexed analysis, using the bead set, different microbead colors are used to identify the sample rather than the bioagent.”

### SUMMARY

Features and advantages of the present invention will become apparent from the following description. Applicants are providing this description, which includes drawings and examples of specific embodiments, to give a broad representation of the invention. Various changes and modifications within the spirit and scope of the invention will become apparent to those skilled in the art from this description and by practice of the invention. The scope of the invention is not intended to be limited to the particular forms disclosed and the invention covers all modifications, equivalents, and alternatives falling within the spirit and scope of the invention as defined by the claims.

The prior art systems for maintaining liquid slurries of small particles (beads) for use in biological or chemical analysis is to use a rigid reservoir for containing the small particles. One prior art device uses a small rigid cup with a stirrer inserted down into the liquid. In the prior art systems, beads tend to be lost over time as a film on the walls as the liquid level drops and also lost at the water/air/wall interface even if the liquid level is kept constant. This requires charging the system with excess beads (which are expensive) and currently requires weekly refilling of the reservoir.

The present invention provides a system for maintaining a liquid slurry of microbeads for use in biological or chemical analysis comprising providing a flexible bag and filling the flexible bag with a slurry of a liquid and microbeads. In one embodiment, the present invention provides an apparatus for maintaining liquid slurries of particles for use in biological or chemical analysis comprising a bag, a liquid contained within the bag, and particles contained within the liquid in the bag.

The present invention has numerous uses. For example the present invention can be used in bioterrorism analysis, medical clinical diagnostics, and environmental analysis. The present invention has use with the Luminex flow cytometer. Since the Luminex platform is a bench-top laboratory instrument it has wide laboratory, commercial, and industrial use. Ion exchange resin beads and glass beads have similar characteristics and the present invention has use with ion exchange resin beads and glass beads. The present invention has use for the bead reagents used in the Autonomous Pathogen Detection System (APDS) for monitoring biowarfare agents. The present invention also has use with Scintillation Proximity Assays (SPA).

The invention is susceptible to modifications and alternative forms. Specific embodiments are shown by way of example. It is to be understood that the invention is not limited to the particular forms disclosed. The invention covers all modifications, equivalents, and alternatives falling within the spirit and scope of the invention as defined by the claims.

### BRIEF DESCRIPTION OF THE DRAWINGS

The accompanying drawings, which are incorporated into and constitute a part of the specification, illustrate specific embodiments of the invention and, together with the general description of the invention given above, and the detailed description of the specific embodiments, serve to explain the principles of the invention.

FIG. 1 illustrates a system for maintaining liquid slurries of small particles for use in biological or chemical analysis.

FIG. 2 illustrates another embodiment of a system for maintaining liquid slurries of small particles for use in biological or chemical analysis

FIG. 3 illustrates the reservoir that maintains liquid slurries of small-diameter polystyrene beads in greater detail.

FIG. 4 illustrates another embodiment of a system for maintaining liquid slurries of small particles for use in a portable pathogen detection system.

FIG. 5 illustrates additional details of one of the bead packs that maintain liquid slurries of the small particles for use in a portable pathogen detection system.

FIG. 6 illustrates another embodiment of a system for maintaining liquid slurries of small particles for use in biological or chemical analysis.

### DETAILED DESCRIPTION OF THE INVENTION

Referring to the drawings, to the following detailed description, and to incorporated materials, detailed information about the invention is provided including the description of specific embodiments. The detailed description serves to explain the principles of the invention. The invention is susceptible to modifications and alternative forms. The invention is not limited to the particular forms disclosed. The invention covers all modifications, equivalents, and alternatives falling within the spirit and scope of the invention as defined by the claims.

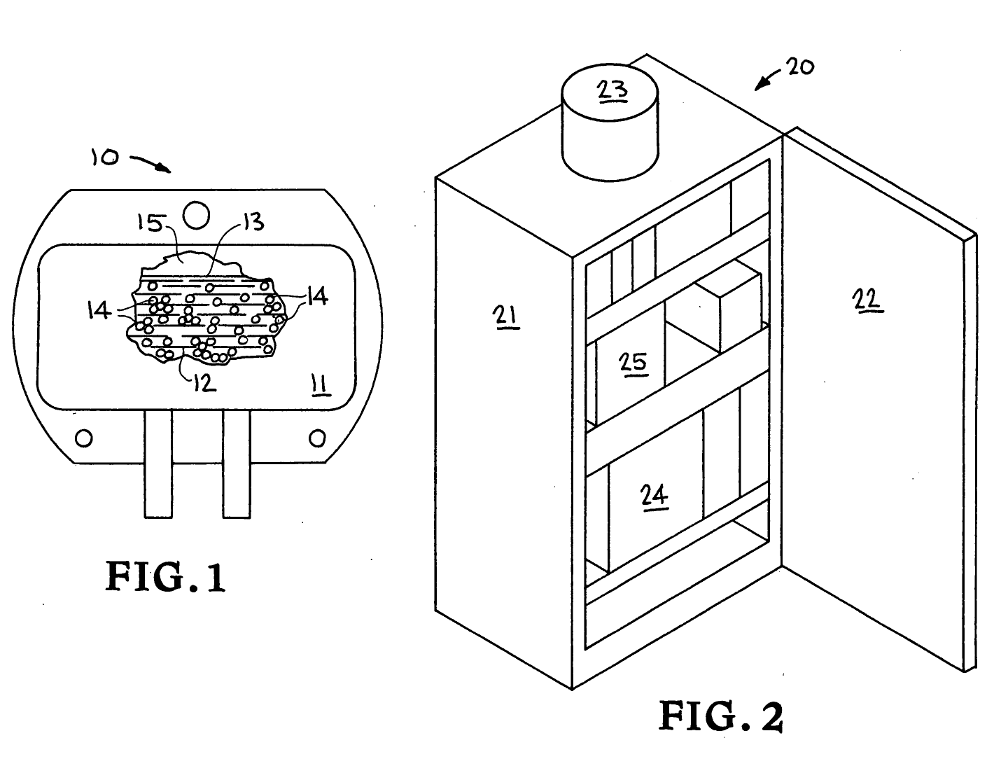

Referring to the drawings and in particular to FIG. 1, one embodiment of a system for maintaining liquid slurries of small particles for use in biological or chemical analysis constructed in accordance with the present invention is illustrated. The system for maintaining liquid slurries of small particles for use in biological or chemical analysis is designated generally by the reference numeral 10. The system 10 comprises a bag 11. The bag 11 is filled with a liquid 12. Small particles 14, for example “microspheres” or “beads,” are contained within the bag 11 in the liquid 12. An air space 15 is located above the surface 13 of the liquid 12.

The system 10 maintains the liquid slurry of small particles 14, i.e., microspheres or “beads” for use in biological or chemical analysis ready for use. In the system 10, the slurry is kept in the collapsible bag reservoir 11 instead of a rigid container reservoir. The collapsible bag 11 minimizes the interface between the walls of the bag 11, the liquid 12, and air space 15, which then minimizes the loss of particles 14 from sticking to the walls and other agglomeration effects. Agitation of the bag 11 can be used to make the slurry ready for use over an extended period of time without refilling or changing reservoirs.

The existing systems for maintaining liquid slurries of small particles for use in biological or chemical analysis use a rigid reservoir. With the rigid reservoir the beads tend to be lost over time as a film on the walls as the liquid level drops and also lost at the water/air/wall interface even if the liquid level is kept constant. The rigid reservoir requires charging the system with excess beads (which are expensive) and currently requires weekly refilling of the reservoir.

In the system of the present invention, the bag 11 is filled with the liquid 12 and the microspheres or beads 14. The system 10 maintains the liquid slurry of small particles by keeping 10 to 100 mL of bead slurries suspended for periods of one to several weeks while frequently (hourly) withdrawing aliquots for use in biological assays. The bag 11 is similar to an intravenous (IV) bag used to administer fluids in medical applications. The bag 11 is watertight and sealed except for ports (usually at the bottom) where tubing can be attached for filling and withdrawing fluids. The bag 11 is filled with the liquid slurry from a port at the bottom of the bag. A small fraction (e.g., about 5%) of the fill volume can be air, which allows the particles to be kept from settling by shaking or tipping the bag. Other methods of keeping the particles ready for use include squeezing the bag 11, pumping liquid in and out of the bag 11, or agitating the particles with sonic energy.

The collapsible bag 11 minimizes the interface between the container, liquid, and air space (if any), which then minimizes the loss of particles from sticking to the walls and other agglomeration effects. As aliquots of the liquid slurry are withdrawn from the bag 11 for use, there is little change in the air/water/wall contact line and the wetted wall area, and no change in the air volume over the liquid. Particles that might be stuck to the wall are readily recovered by shaking or tipping the bag. Continuous or frequent agitation of the bag keeps the slurry ready for use over an extended period of time. Another advantage of this approach is that no ambient air needs be introduced to the collapsible bag, so the risk of contamination from the environment is eliminated.

The system 10 of the present invention has many uses. For example the system 10 has use in bioterrorism analysis, medical clinical diagnostics, and environmental analysis. The system 10 has use with the Luminex flow cytometer. Since the Luminex platform is a bench-top laboratory instrument the system 10 has wide laboratory, commercial, and industrial use. Ion exchange resin beads and glass beads have similar characteristics and the system 10 has use with ion exchange resin beads and glass beads.

The system 10 has use with Scintillation Proximity Assays (SPA). Scintillation Proximity Assays utilize microscopic beads which contain a scintillant that can be stimulated to emit light. This stimulation event only occurs when radiolabeled molecules of interest are bound to the surface of the bead then blue light is emitted that can be detected on standard scintillation counters. SPA Scintillation beads are microspheres containing scintillant which emit light in the blue region of the visible spectrum. As a result, these beads are ideally suited to use with photomultiplier tube (PMT) counters such as the TopCount or MicroBeta. Two types of core SPA Scintillation bead are available—yttrium silicate (YSi) and Polyvinyltoluene (PVT). A number of biological coatings also exist for each core bead type to enable receptor binding, kinase, molecular interaction and radioimmunoassays to be investigated. The system 10 incorporating Scintillation Proximity Assays has use in Enzme SPA applications that can be used to identify potential new enzyme inhibitors, measure enzyme activity, and perform kinetic analysis. Kinases play pivotal roles in many signal transduction cascades and consequently kinase activities remain a key focus of academic and pharmaceutical research. The SPA beads can be used in the study of tyrosine and serine/threonine kinases using both peptide and protein substrates. Receptor-binding SPAs can be configured to determine receptor kinetics, saturation binding, or to detect inhibitors of radioligand binding. SPA has been successfully applied to receptor-binding assays by immobilizing receptors directly to SPA beads via a number of coupling methods. SPA technology has been successfully applied to the study of a variety of molecular interactions. Protein: protein interactions. Protein: peptide interactions. Protein: DNA interactions Cell adhesion molecule interactions. SPA radioimmunoassay is based on the reaction of antibody-bound ligand with SPA beads coated with either a secondary antibody or Protein A.

Cytostar-T™ Scintillating Microplates have been developed specifically for the study of cell-based assays using SPA technology. Cytostar-T Scintillating Microplates can be utilized in non-invasive and real time analysis of cellular events. DMFK assays are a range of kits for use in drug metabolism and pharmacokinetic studies. DMPK assays provide an economical and higher throughput alternative to conventional assay methodologies such as equilibrium dialysis, HFLC, and ultrafiltration.

Referring to FIG. 2, another embodiment of a system for maintaining liquid slurries of small particles for use in biological or chemical analysis is illustrated. One of the methods a terrorist might use to disperse a biowarfare agent is through an aerosol attack. In fact, the anthrax mail room release in 2001 and the ricin release in 2004 involved relatively small amounts of deadly material. Countering such threats in an effective manner requires an automated system that continuously monitors the air, quickly analyzes samples, and identifies a wide range of agents without false positives.

The embodiment of a system for maintaining liquid slurries of small particles for use in biological or chemical analysis is a system used for the bead reagents in the Autonomous Pathogen Detection System 20, or APDS developed by the Lawrence Livermore National Laboratory. The Autonomous Pathogen Detection System 20 is described in the article, “Reducing the Threat of Biological Weapons” in the June 1998 issue of Science and Technology Review. The disclosure provided in the article, “Reducing the Threat of Biological Weapons” in the June 1998 issue of Science and Technology Review is incorporated herein by this reference. The Autonomous Pathogen Detection System 20 is also described in the article “Detecting Bioaersols When Time is of the Essence” in the October 2004 issue of Science and Technology Review. The disclosure in the article “Detecting Bioaersols When Time is of the Essence” in the October 2004 issue of Science and Technology Review is incorporated herein by reference.

The Lawrence Livermore National Laboratory researchers received seed funding from the Laboratory Directed Research and Development Program to develop an instrument that counters bioterrorism by providing a rapid early warning system for pathogens, such as anthrax. That instrument, the Autonomous Pathogen Detection System (APDS) 20, is now ready for deployment to better protect the public from a bioaerosol attack, and the development team has been honored with a 2004 R&D 100 Award.

As illustrated in FIG. 2, the Autonomous Pathogen Detection System 20 comprises a lectern-size cabinet 21 with a door 22. A continuous air sample collection system 23 draws samples of air into the Autonomous Pathogen Detection System 20. The detection section 24 includes both an immunoassay detector and a nucleic-acid amplification and detection detector. A reservoir 25 maintains liquid slurries of small particles for use in biological or chemical analysis.

As the Autonomous Pathogen Detection System 20 collects air samples, it first runs them through an immunoassay detector. If that detector returns a positive result, the Autonomous Pathogen Detection System 20 performs a second assay based on nucleic-acid amplification and detection. Having two different assay systems increases system reliability and minimizes the possibility of false positives. In another configuration, the Autonomous Pathogen Detection System 20 can perform the nucleic-acid amplification and detection as the first assay.

The immunoassay detector incorporates liquid arrays, a multiplexed assay that uses small-diameter polystyrene beads (microbeads) coated with thousands of antibodies. Each microbead is colored with a unique combination of red- and orange-emitting dyes. The number of agents that can be detected in a sample is limited only by the number of colored bead sets. When the sample is exposed to the beads, a bioagent, if present, binds to the bead with the appropriate antibody. A second fluorescently labeled antibody is then added to the sample, resulting in a highly fluorescent target for flow analysis. Preparing the sample and performing this first analysis can take less than 30 minutes.

Another way the Autonomous Pathogen Detection System 20 makes use of microbeads is in multiplexed nucleic-acid detection. After the nucleic acid sequences are amplified, the products of this amplification are bound to microbeads and identified by the same flow detector used for the immunoassay.

The Autonomous Pathogen Detection System 20 monitors the air for the three types of biological threat agents: bacteria, viruses, and toxins. Because it operates continuously, the system can detect low concentrations of bioagents that might go undetected by a system that is triggered only when the overall number of particles in the air is high. The Autonomous Pathogen Detection System 20 collects aerosol samples, prepares them for analysis, and tests for multiple biological agents simultaneously. This automation reduces the cost and staffing that would be required to manually analyze samples. The lectern-size Autonomous Pathogen Detection System 20 can be placed in airports, office buildings, performing arts centers, mass transit systems, sporting arenas—anywhere an attack might be launched.

The article, “Autonomous Detection of Aerosolized Bacillus anthracis and Yersinia pestis” by Mary T. McBride, Don Masquelier, Benjamin J. Hindson, Anthony J. Makarewicz, Steve Brown, Keith Burris, Thomas Metz, Richard G. Langlois, Kar Wing Tsang, Ruth Bryan, Doug A. Anderson, Kodumudi S. Venkateswaran, Fred P. Milanovich, and Bill W. Colston, Jr. in Analytical Chemistry, vol. 75, pages 5293-5299 (2003) describes a fully autonomous pathogen detection system (APDS) capable of continuously monitoring the environment for airborne biological threat agents. The system is designed to provide early warning to civilians in the event of a terrorist attack. The disclosure in the article, “Autonomous Detection of Aerosolized Bacillus anthracis and Yersinia pestis” by Mary T. McBride, Don Masquelier, Benjamin J. Hindson, Anthony J. Makarewicz, Steve Brown, Keith Burris, Thomas Metz, Richard G. Langlois, Kar Wing Tsang, Ruth Bryan, Doug A. Anderson, Kodumudi S. Venkateswaran, Fred P. Milanovich, and Bill W. Colston, Jr. in Analytical Chemistry, vol. 75, pages 5293-5299 (2003) is incorporated herein by reference.

The APDS is completely automated, offering aerosol sampling, in-line sample preparation fluidics, multiplexed detection and identification immunoassays, and orthogonal, multiplexed PCR (nucleic acid) amplification and detection. The APDS uses polystyrene microbeads. The beads are embedded with precise ratios of red and infrared fluorescent dyes yielding an array of 100 different bead classes, where each class has a unique spectral address. The immunoassays employ a sandwich immunoassay format, where antigen-specific capture antibodies are immobilized on the beads, antigen is introduced and allowed to bind the beads, and the bound analyte is subsequently detected using secondary antibodies labeled with the fluorescent reporter, phycoerythrin (PE). Each optically encoded and fluorescently labeled microbead is then interrogated by the flow cytometer. A classification laser (635 nm) excites the dye molecules inside the beads, and a reporter laser (532 nm) excites the fluorescent molecules bound to the bead surfaces. The flow cytometer is capable of reading hundreds of beads per second; analysis is completed in 60 s. Upon completion of the automated immunoassay, the fluidics module dispenses the sample to the flow cytometer for analysis. After analysis, the sample is pumped to waste and the system is flushed in preparation for the next sample.

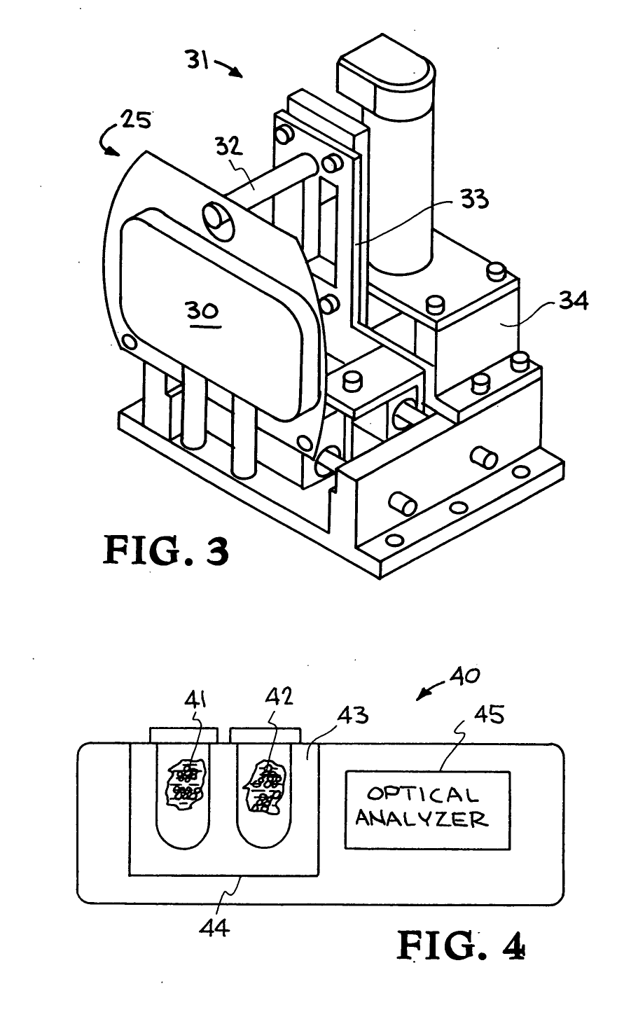

Referring now to FIG. 3, the reservoir 25, initially shown in FIG. 2, that maintains liquid slurries of small-diameter polystyrene beads (microbeads) is illustrated in greater detail. The reservoir 25 comprises a bag 30. The bag 30 is similar to an intravenous (IV) bag used to administer fluids in medical applications. The bag 30 is made of a flexible material, is watertight, and is sealed. The bag 30 can be made of plastic, multi-layer plastic, or other flexible material. A port and tubing connected to the bag 30 is used for withdrawing fluids and microbeads contained within the bag 30. The bag 30 is filled with the liquid slurry and microbeads from a resealable port at the bottom of the bag.

The bag 30 is filled with a liquid. The microbeads are contained within the bag 30 in the liquid. An air space is located above the surface of the liquid. A system 31 for shaking the bag 30 provides agitation of the contents of the bag 30 to keep the slurry ready for use over an extended period of time without refilling or changing reservoirs. The bag 30 is held by a moveable arm 32. The moveable arm 32 is connected to a moveable frame 33. The moveable frame 33 and movable arm 32 are driven by a motor located in the main housing 34.

The reservoir 25 maintains the liquid slurry of small microspheres or beads ready for use. The beads are small-diameter polystyrene beads (microbeads) coated with thousands of antibodies. Each microbead is colored with a unique combination of red- and orange-emitting dyes. The number of agents that can be detected in a sample is limited only by the number of colored bead sets. When the sample is exposed to the beads, a bioagent, if present, binds to the bead with the appropriate antibody. A second fluorescently labeled antibody is then added to the sample, resulting in a highly fluorescent target for flow analysis. Preparing the sample and performing this first analysis can take less than 30 minutes.

Referring to FIG. 4, another embodiment of a system for maintaining liquid slurries of small particles for use in a portable pathogen detection system is illustrated. The portable pathogen detection system is designated generally by the reference numeral 40. The principal components of the portable pathogen detection system 40 as illustrated in the embodiment of FIG. 4 are: optically encoded microbead reagents (bead packs) 41 and 42, a mixing chamber 43 located in a vibration unit 44, and an optical analyzer 45.

As shown, the portable pathogen detection system 40 is a handheld device and comprises a casing or housing which can be held in a human hand, the housing includes the mixing chamber 43 within which bead packs 41 and 42 are located. The mixing chamber 43 is carried by the vibration or mixing unit 44. The analyzer is generally indicated at 45.

Samples are added to the bead packs 41 and 42 containing optically encoded microbeads. Each microbead contains a capture ligand and bioagent-specific antibodies. Each microbead, in addition to the standard sample capture assay, contains special attachment sites. The bead packs 41 and 42 are then placed in the mixing chamber 43.

The portable pathogen detection system 40 and the bead packs 41 and 42 can be the type of systems described and illustrated in U.S. Pat. No. 6,905,885 issued Jan. 14, 2005 to Billy W. Colston, Matthew Everett, Fred P. Milanovich, Steve B. Brown, Kodumudi Vendateswaran, and Jonathan N. Simon for a portable pathogen detection system which describes and illustrates the detection of pathogens and toxins, particularly a highly flexible liquid array that utilizes optically encoded microbeads as the templates for biological assays, and more particularly to a micro-immunoassay (handheld) system wherein target biological samples are optically labeled and captured on microbeads, which are in turn captured on an ordered array or disposable capture substrate and optically read. U.S. Pat. No. 6,905,885 issued Jan. 14, 2005 to Billy W. Colston, Matthew Everett, Fred P. Milanovich, Steve B. Brown, Kodumudi Vendateswaran, and Jonathan N. Simon for a portable pathogen detection system is incorporated herein by reference.

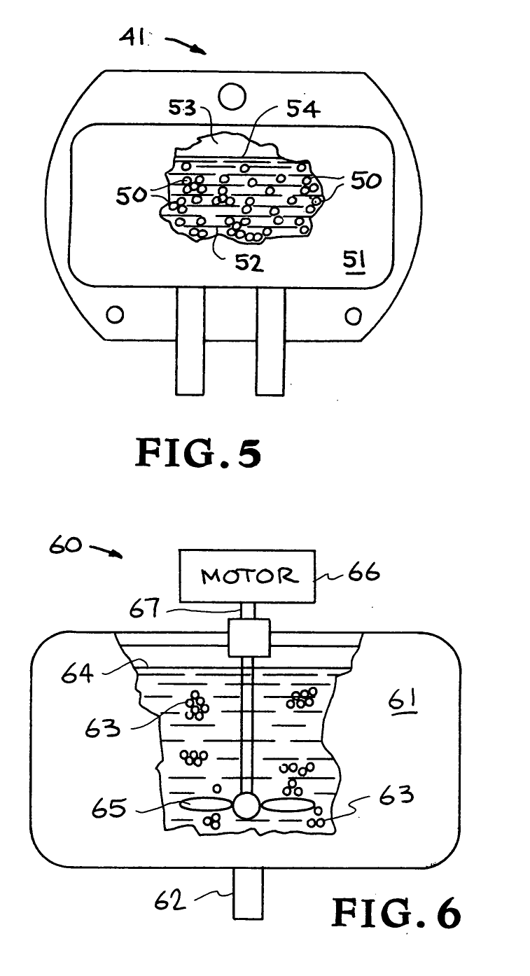

Referring now to FIG. 5, one of the bead packs, beadpack 41 that maintains liquid slurries of optically encoded microbeads (microbeads) is illustrated in greater detail. The beadpack 41 comprises a bag 51. The bag 51 is similar to an intravenous (IV) bag used to administer fluids in medical applications. The bag 51 is made of a flexible material, is watertight, and is sealed. The bag 51 is filled with a liquid 52. The microbeads 50 are contained within the bag 51 in the liquid 52. An air space 53 is located above the surface 54 of the liquid 52. The beadpack 41 maintains the liquid slurry of microbeads 50 and liquid 52 ready for use. The microbeads 50 are small-diameter beads coated with antibodies.

Referring now to FIG. 6, another embodiment of a bag that maintains liquid slurries of optically encoded microbeads (microbeads) is illustrated. The bag designated in general by the reference numeral 60 is made of a flexible material, is watertight, and is sealed. The bag 60 is made of a material 61 which can be plastic, multi-layer plastic, or other flexible material. A port and tubing 62 at the bottom of the bag 60 is used for withdrawing fluids and microbeads 63. The bag 60 is filled with the liquid slurry and the microbeads 63 from a resalable port at the bottom of the bag.

The bag 60 is filled with a liquid 64. The microbeads 63 are contained within the bag 60 in the liquid 64. An air space is located above the surface of the liquid 64. An impeller 65 provides agitation of the contents of the bag 60 to keep the slurry ready for use over an extended period of time without refilling or changing reservoirs. The impeller 65 is driven by a motor 66 through the shaft 67.

While the invention may be susceptible to various modifications and alternative forms, specific embodiments have been shown by way of example in the drawings and have been described in detail herein. However, it should be understood that the invention is not intended to be limited to the particular forms disclosed. Rather, the invention is to cover all modifications, equivalents, and alternatives falling within the spirit and scope of the invention as defined by the following appended claims.

The invention claimed is:

1. An apparatus for maintaining liquid slurries of particles for use in biological or chemical analysis, comprising:
a bag, a liquid contained within said bag, and
particles contained within said liquid in said bag.

2. The apparatus for maintaining liquid slurries of particles for use in biological or chemical analysis of claim 1 wherein said bag is a flexible bag that is watertight and sealed.

3. The apparatus for maintaining liquid slurries of particles for use in biological or chemical analysis of claim 1 wherein said bag is made of flexible material.

4. The apparatus for maintaining liquid slurries of particles for use in biological or chemical analysis of claim 1 wherein said bag is made of plastic.

5. The apparatus for maintaining liquid slurries of particles for use in biological or chemical analysis of claim 1 wherein said bag is made of multi-layer plastic.

6. The apparatus for maintaining liquid slurries of particles for use in biological or chemical analysis of claim 1 wherein said bag is a plastic bag that is watertight and sealed.

7. The apparatus for maintaining liquid slurries of particles for use in biological or chemical analysis of claim 1 wherein said bag is a collapsible bag that provides a reservoir for said particles and said liquid.

8. The apparatus for maintaining liquid slurries of particles for use in biological or chemical analysis of claim 1 including a port for withdrawing said fluids and particles from said bag.

9. The apparatus for maintaining liquid slurries of particles for use in biological or chemical analysis of claim 1 including a resealable port for filling said bag with said liquid and said particles.

10. The apparatus for maintaining liquid slurries of particles for use in biological or chemical analysis of claim 1 wherein said particles are beads.

11. The apparatus for maintaining liquid slurries of particles for use in biological or chemical analysis of claim 1 wherein said particles are microspheres.

12. The apparatus for maintaining liquid slurries of particles for use in biological or chemical analysis of claim 1 including an air space located above said liquid in said bag.

13. The apparatus for maintaining liquid slurries of particles for use in biological or chemical analysis of claim 1 wherein said liquid and said particles form a bead slurry.

14. The apparatus for maintaining liquid slurries of particles for use in biological or chemical analysis of claim 1 wherein said liquid and said particles form a bead slurry of 1 mL to 1,000 mL.

15. The apparatus for maintaining liquid slurries of particles for use in biological or chemical analysis of claim 1 wherein said liquid and said particles form a bead slurry of 1 mL to 100 mL.

16. The apparatus for maintaining liquid slurries of particles for use in biological or chemical analysis of claim 1 wherein said liquid and said particles form a bead slurry of 10 mL to 100 mL.

17. The apparatus for maintaining liquid slurries of particles for use in biological or chemical analysis of claim 1 including a shaker operatively connected to said bag for agitating said liquid and said particles.

18. The apparatus for maintaining liquid slurries of particles for use in biological or chemical analysis of claim 1 including a source of sonic energy operatively connected to said bag for agitating said liquid and said particles.

19. The apparatus for maintaining liquid slurries of particles for use in biological or chemical analysis of claim 1 including a pump operatively connected to said bag for pumping fluids in said bag and agitating said liquid and said particles.

20. The apparatus for maintaining liquid slurries of particles for use in biological or chemical analysis of claim 1 including an impeller in said bag for agitating said liquid and said particles.

21. A method of maintaining a liquid slurry of microbeads for use in biological or chemical analysis, comprising the steps of:
providing a flexible bag, and
filling said flexible bag with a slurry of a liquid and microbeads.

22. The method of maintaining liquid slurry of microbeads for use in biological or chemical analysis of claim 21 including the step of keeping the liquid slurry of microbeads ready for use by agitating said slurry of a liquid and microbeads.

23. The method of maintaining liquid slurry of microbeads for use in biological or chemical analysis of claim 21 including the step of keeping the liquid slurry of microbeads ready for use by agitating said slurry of a liquid and microbeads using an impeller.

24. The method of maintaining liquid slurry of microbeads for use in biological or chemical analysis of claim 21 including the step of keeping the liquid slurry of microbeads ready for use by agitating said slurry of a liquid and microbeads with sonic energy.

25. The method of maintaining liquid slurry of microbeads for use in biological or chemical analysis of claim 21 including the step of keeping the liquid slurry of microbeads ready for use by agitating said slurry of a liquid and microbeads by squeezing said bag.

26. The method of maintaining liquid slurry of microbeads for use in biological or chemical analysis of claim 21 including the step of keeping the liquid slurry of microbeads ready for use by agitating said slurry of a liquid and microbeads by pumping said liquid in and out of said bag.

27. The method of maintaining liquid slurry of microbeads for use in biological or chemical analysis of claim 21 including the step of keeping the liquid slurry of microbeads ready for use by agitating said slurry of a liquid and microbeads by shaking said bag.

28. The method of maintaining liquid slurry of microbeads for use in biological or chemical analysis of claim 21 including the step of keeping the liquid slurry of microbeads ready for use by agitating said slurry of a liquid and microbeads by tipping said bag.
